(19) United States
(12) Patent Application Publication
(10) Pub. No.: US 2008/0039553 A1
(43) Pub. Date: Feb. 14, 2008

(54) Synthetic resin usable for various purposes that contains different kinds of tiny particles each with a diameter of nanometers and method for manufacture of such a synthetic resin

(76) Inventor: Masataka Furui, Sennan-gun (JP)

Correspondence Address: MASATAKA FURUI, 2-10-5 Okubonaka, Sennan-gun, JP

(21) Appl. No.: 11/502,968

(22) Filed: Aug. 14, 2006

(51) Int. Cl. C08K 7/00

(52) U.S. Cl. 523/220

(57) ABSTRACT

A resin product is provided wherein tiny particles of different kinds of metals with different specific gravities and those of different kinds of nonmetals also with different specific gravities are equally mixed together, each said particle being crushed into a diameter of nanometers. To be more exact, different kinds of metals and different kinds of nonmetals are crushed into fine grains of powder each with a diameter of several tens of microns, and then these fine grains are pulverized into finer grains of powder each with a diameter of several hundreds of nanometers, and further, thereafter, a great impact is given to these finer grains of powder so that the very tiny particles of powder of metal and nonmetal are mixed with a resin product equally or uniformly, or in such a manner that those tiny particles are distinctly separate from one another in the resin.

### FIELD OF INVENTION

This invention relates to a method for kneading different kinds of metals and different kinds of nonmetals as crushed into powders into a synthetic resin product in such a manner that they are not too close to one another nor are they fixed to one another but in such a manner that they are distinctly or sufficiently separate from one another, and more particularly to such a method for kneading a total of ten or more such kinds of metals and nonmetals into a synthetic resin product.

### BACKGROUND OF THE INVENTION

It has been widely known that tiny particles of metal and nonmetal have various effects. Then there have been already in existence products as obtained by mixing extremely small particles of different kinds metals and different kinds of nonmetals, for example, those particles each having a diameter of several microns or several tens of microns, with a synthetic resin or synthetic fibers so that those particles may have various effects. Also, there exists a technique for mixing tiny metallic or nonmetallic particles nanometers in diameter with a resin product.

As for kneading metal and nonmetal into a synthetic resin such that it will manifest its maximum good effect as well as such that its minute particles will be sufficiently separate from one another in the resin, it is possible to mix minute particles of one or two kinds of metals or nonmetals nanometers in diameter with the resin in such a manner, although all the metals and nonmetals of different kinds each have a different specific gravity from the other kinds of metals and nonmetals. However, since, to repeat, all the different kinds of metals and different kinds of nonmetals have different specific gravities, it has not been possible simultaneously to mix tiny particles of ten or more kinds of metals or nonmetals of nanometers in diameter with a synthetic resin in such a manner.

Thus it is desirable and necessary that one can mix tiny particles of ten or more kinds of metals or nonmetals of nanometers in diameter with a synthetic resin in such a manner, without damaging the characteristics of the metals and nonmetals as least as possible or without losing them.

### SUMMARY OF THE INVENTION

Then the inventor hereof has developed such a mixing technique, that is, a method for mixing tiny particles of ten or more kinds of metals or nonmetals with a synthetic resin in such a manner. This is possible if we pulverize different kinds of metals and different kinds of nonmetals to very fine particles each with a diameter of several hundreds of nanometers and thereafter treat these fine particles in a special manner.

Accordingly a primary object of this invention is to make it possible to pulverize different kinds of metals with different specific gravities and also different kinds of nonmetals with different specific gravities to very fine particles each with a diameter of several hundreds of nanometers and then mix those particles in such a manner that they are too close to one another nor are they too distant from one another but such that they are distinctly or sufficiently from one another.

It is, in fact, not possible to crush different kinds of metals with different specific gravities and different kinds of nonmetals with also different specific gravities into very fine powders each with a diameter of nanometers after mixing those metals and nonmetals together. Thus, according to the invention, firstly, different kinds of metals and nonmetals are individually broken into small pieces of several millimeters in diameter, and as a next step, each of these small pieces is crushed into smaller fragments with a diameter of several tens of microns by a method well known in the art, and finally these crushed fragments are further made into finer powders each with several hundreds of nanometers also by a well known method Thereupon the very fine powders thus obtained are placed, for several minutes, into a pressure-resistant container having a high level of energy where air is highly ionized. Next, these very small particles obtained by the ionization under high pressure are simultaneously put into, and mixed with, such a liquefied synthetic resin as liquefied rayon or liquefied polyester, so that those particles may be sent off in different directions within the liquefied synthetic resin.

Further, as a final step, the inventor hereof makes the synthetic resin obtained by the foregoing method into fiber filaments in order to accomplish the above-mentioned primary object of the invention.

### BRIEF DESCRIPTION OF THE DRAWINGS

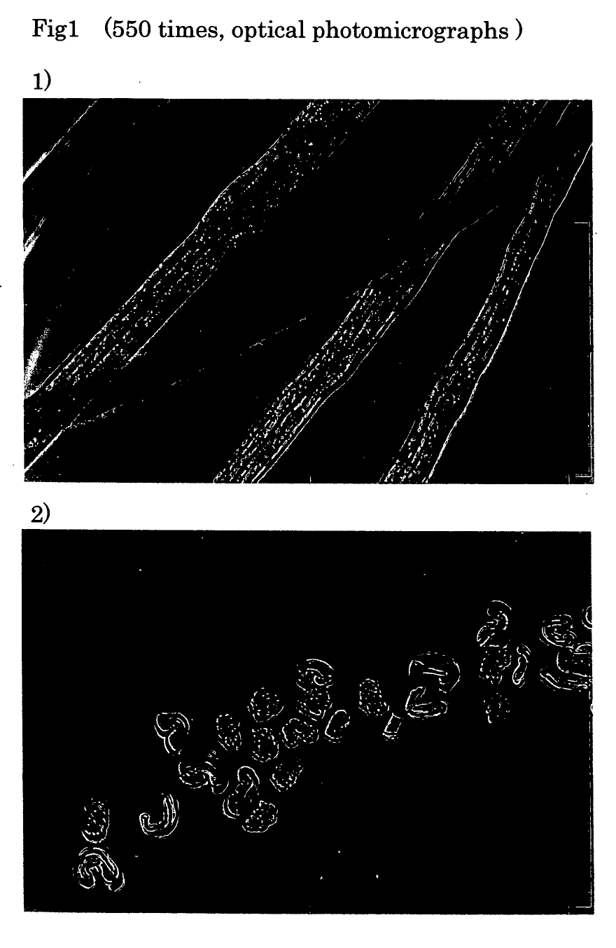

FIG. 1 illustrates the condition in which different kinds of metals and different kinds of nonmetals are mixed with a liquefied synthetic resin such that those materials are sent off in different directions within the resin.
1) Photomicrograph of one section of a rayon fiber filament produced according to the invention
2) Photomicrograph of one side of a fiber filament

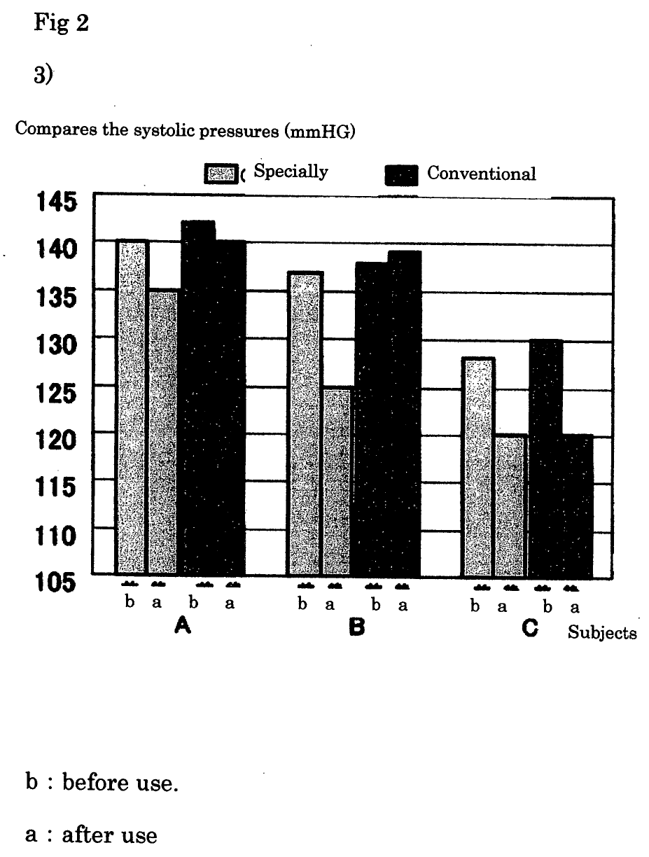

FIG. 2 compares the use of bedclothes as manufactured using fibers obtained according to the invention with that of conventional bedclothes.
3) Graph that compares different systolic pressures (mmHg)

### DETAILED DESCRIPTION OF THE PREFERRED EMBODIMENT

The main object of the preferred embodiment of this invention is to mix very small particles of plural kinds of metals and nonmetals of nanometers in diameter with resin in such a manner that those particles are distinctly separate from one another in the resin and thus to provide such products as relax a human body as well as those that activate organic matter.

Then, in this invention, to start with, the following metals and nonmetals each are crushed into small fragments with a diameter of several millimeters:

| | |
|---|---|
| metals | sodium |
| | magnesium |
| | aluminum |
| | potassium |
| | calcium |
| | titanium |
| | chromium |
| | manganese |
| | iron |
| | nickel |
| | copper |
| | silver |
| | zinc |
| nonmetals | silicon |
| | carbon |

Then, each of these broken pieces is pulverized into finer grains of powder with a diameter of several tens of microns by a method well known in the art. Further the small grains of powder now obtained in such a manner are crushed into much finer grains each with a diameter of several hundreds of nanometers also by a well-known method. Next the very minute particles thus obtained are placed, for several minutes, into a pressure-resistant container wherein air is ionized to a very high concentration and that has a high level of energy therein. Lastly, after being placed into the pressure-resistant container, all the particles are simultaneously are put into, and mixed with, liquefied synthetic resin, in most cases, liquefied rayon, in such a manner that those particles may be sent off in different directions within the liquefied synthetic resin.

FIGS. 1 and 2 are photomicrographs of fiber filaments into which the synthetic resin produced by the above-mentioned method is made through a method well known in the art.

By mixing very fine particles of different kinds of metals and/or nonmetals with synthetic resin, one can immeasurably increase the surface area of the synthetic resin almost without doing any damage to its inherent properties. This can be done even if the amount of addition of these particles to the synthetic resin is small. In other words, one may expect these materials will have an increased effect on the synthetic resin even if that amount is not great. This is possible without regard to the specific gravities of the different kinds of metals and nonmetals used. These minute materials, also without reference to their specific gravities, can be mixed with the resin almost uniformly, or almost such that those materials are distinctly separate from one another within the resin. Thus these very small crushed particles of metals and nonmetals each with a diameter of nanometers can achieve a synergistic effect in the resin, with the result that the present invention makes it possible to obtain synthetic resin products which have been unavailable up until now.

In FIG. 1 are shown photomicrographs that illustrate rayon fiber filaments containing sodium, magnesium, aluminum, potassium, calcium, titanium, chromium, manganese, iron, nickel, copper, silver, zinc, silicon, and carbon as into fine grains of powder each with a diameter of nanometers are mixed together uniformly, or in such a manner that they are not too close to one another nor are they fixed to one another but in such a manner that they are distinctly or sufficiently separate from one another.

If one wishes to know what excellent relaxing effects the synthetic resin product obtained by the method of the invention may have on a human body, he should have a look at Graph 3 of FIG. 2, which shows the relaxing effects that bedclothes produced using the rayon fiber filaments obtained by the method of the present invention have on a human body. Measurements shown in FIG. 2 have actually been done by Dr. Fujihisa Kinoshita, who specializes in the Science of Athletics for Health at Wakayama Health Center. The Graph 3 of FIG. 2 clearly demonstrates a difference between bedclothes using the rayon fiber filaments of the invention and those not using them in respect of their effects on the human body.

Also the Graph 3 of FIG. 2 compares the systolic pressures (mmHg) of three male subjects (A 45 years old, B 54 years old and C 55 years old) with one another. To be exact, each of these three male subjects was made to sleep using specially processed bedclothes, a specially processed pillow case, a specially processed bedsheet and a specially processed towel (i.e., those manufactured using synthetic fiber filaments of the present invention) and also to sleep using conventional bedclothes, a conventional pillow case, a conventional bedsheet and a conventional towel, and in each subject its systolic pressure measured during the sleeping time when it was made to sleep using the specially processed products was compared with that measured during the sleeping time when it was made to sleep using the conventional products.

As a result, it was shown that one can reduce the systolic pressure in great measure by the specially processed products of the invention.

Further if one produces a container of synthetic resin for food by the method of this invention, it makes possible to maintain the freshness of foods much more effectively than before. Furthermore, if one prepares building materials by using the synthetic resin product of the present invention, one can improve deodorization and the effects of retaining warmth as well as of maintaining the freshness of indoor air. In addition, if a filter for a liquid or gas is manufactured according to the method of the invention, not only a much better effect can be expected from such a filter than before, but using such a filter could help improve environmental protection.

Having above indicated, a preferred embodiment the present invention, it will occur to those skilled in the art that modifications and alternatives can be practiced within the spirit of the invention. It is accordingly intended to define the scope of the invention only as indicated in the following claims.

What is claimed is:

1. Synthetic resin usable for various purposes that contains tiny particles of a total of four or more different kinds of metals and nonmetals, said tiny particles each having a diameter which ranges from 100 to 800 nanometers and a method for manufacture of such a synthetic resin.

2. Synthetic resin usable for various purposes that contains tiny particles of a total of three or more different kinds of metals, said tiny particles each having a diameter which ranges from 100 to 800 nanometers and a method for manufacture of such a synthetic resin.

3. Synthetic resin usable for various purposes that contains tiny particles of a total of three or more different kinds of nonmetals, said tiny particles each having a diameter which ranges from 100 to 800 nanometers and a method for manufacture of such a synthetic resin.

4. Synthetic resin of claim 1 wherein said tiny particles are those of resin fiber filaments and a method for manufacture of such a synthetic resin.

5. Synthetic resin of claim 2 wherein said tiny particles are those of resin fiber filaments and a method for manufacture of such a synthetic resin.

6. Synthetic resin of claim 3 wherein said tiny particles are those of resin fiber filaments and a method for manufacture of such a synthetic resin.
